(19) United States
(12) Patent Application Publication
(10) Pub. No.: US 2018/0341717 A1
(43) Pub. Date: Nov. 29, 2018

(54) PROVIDING INSTANT PREVIEW OF CLOUD BASED FILE

(71) Applicant: MICROSOFT TECHNOLOGY LICENSING, LLC, Redmond, WA (US)

(72) Inventors: Jose Emmanuel MIRANDA-STEINER, Seattle, WA (US); Steven J. BAILEY, Bellevue, WA (US); John D. RODRIGUES, Woodinville, WA (US)

(73) Assignee: MICROSOFT TECHNOLOGY LICENSING, LLC, Redmond, WA (US)

(21) Appl. No.: 15/607,254

(22) Filed: May 26, 2017

(51) Int. Cl. G06F 17/30; H04L 29/08

(52) U.S. Cl. CPC G06F 17/30902; H04L 67/10

(57) ABSTRACT

Variety of approaches to provide an instant preview of a cloud based file are described. A file management application initiates operation(s) to provide an instant preview of a cloud based file upon detecting an intent to preview the cloud based file. Next, a lack of a local previewer associated with the cloud based file is confirmed. A preview is requested from a server associated with the cloud based file. The preview includes a presentation of the cloud based file. Upon receiving the preview associated with the cloud based file from the server, the preview is rendered. The preview may be a rich, instant preview.

### BACKGROUND

Information exchange has changed processes associated with work and personal environments. Automation and improvements in processes have expanded the scope of capabilities offered for personal and business data consumption. With the development of faster and smaller electronics, execution of mass processes at cloud systems have become feasible. Indeed, applications provided by data centers, data warehouses, and data workstations have become common features in modern personal and work environments. Cloud based storage service(s) provide hosting, management, and/or other file service(s) that encompass a multitude of file types for which a client application may lack support.

Increasingly, cloud based resources are utilized for variety of services that include hosting and/or management services, among others that facilitate hosting, processing, classification, and/or management, among other operations associated with assets such as files. However, there are currently substantial gaps in dynamically providing content preview support in client application(s). Personnel resources are unnecessarily consumed for managing and creating support for a multitude of file types that are hosted by cloud based services. Lack of relevant preview solutions to dynamically render content of cloud based file(s) causes poor management of personnel resources and time when attempting to preview cloud based file(s).

SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an instant preview of a cloud based file. A client application such as a file management application, according to embodiments, may initiate operations to provide a preview of a cloud based file upon detecting an intent to view the cloud based file. Next, a lack of a local previewer associated with the cloud based file may be confirmed. Upon confirming the lack of local preview support for the cloud based file, the preview may be requested from a server associated with the cloud based file. The preview may include a presentation of the cloud based file. Upon receiving the preview associated with the cloud based file from the server, the preview may be rendered on the local computing device. The preview may be a rich instant preview with particular levels of functionality such as editing functionality.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing an instant preview of a cloud based file, according to embodiments;

FIG. 2 is a display diagram illustrating example components of a file management application that provides an instant preview of a cloud based file, according to embodiments;

FIG. 3 is a display diagram illustrating components of a scheme to provide an instant preview of a cloud based file, according to embodiments;

FIG. 4 is a display diagram illustrating another example of a scheme to provide an instant preview of a cloud based file, according to embodiments;

FIG. 5 is a display diagram illustrating an additional example of a scheme to provide an instant preview of a cloud based file, according to embodiments;

FIG. 6 is a simplified networked environment, where a system according to embodiments may be implemented;

FIG. 7 is a block diagram of an example computing device, which may be used to provide an instant preview of a cloud based file, according to embodiments;, according to embodiments; and

FIG. 8 is a logic flow diagram illustrating a process for providing an instant preview of a cloud based file, according to embodiments.

### DETAILED DESCRIPTION

As briefly described above, a file management and/or synchronization application may provide an instant preview of a cloud based file. In an example scenario, a client application such as a file synchronization application may detect an intent to preview the cloud based file. A cloud based file may include a file hosted by a cloud based storage provider. For example, the cloud based storage provider may partition the file to multiple portions which may be distributed to a variety of storage components and/or storage providers. The client application, such as the file synchronization application, may store a representation of the cloud based file. The representation may include a link and/or a portion of the cloud based file (such as a beginning section of the cloud based file). Upon receiving an access request to the cloud based file (from the client application), the cloud based storage provider may retrieve and transmit the various partitions of the cloud based file from the storage components and/or storage providers. The cloud based storage provider may also optimize access to the cloud based file based on resource availability and/or other criteria.

A client application (such as the file synchronization application) and/or a local operating system may lack module(s) and/or feature(s) to render the cloud based file. The client application may consume unnecessary resources and/or may lack necessary resources to support module(s) and/or feature(s) to render variety of file types stored by a vast resource such as the cloud based storage provider. As such, a client application may confirm an availability of a local previewer prior to an attempt to render the cloud based file (in response to a detected request to preview the cloud based file).

Upon confirming a lack of a local previewer associated with the cloud based file, the file synchronization application may request a preview from a server associated with the cloud based file. The preview may include a presentation of the cloud based file. The presentation may include image(s) of a content of the cloud based file. In another example scenario, the usage experience may duplicate interactive element(s) that may be located in the cloud based file (such as a fillable form components). Upon receiving the preview associated with the cloud based file from the server, the preview may be rendered on a user's local machine. Alternatively, the file management application may instruct the operating system to have the preview rendered by other application and/or module capable of rendering the preview.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing an instant preview of a cloud based file. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

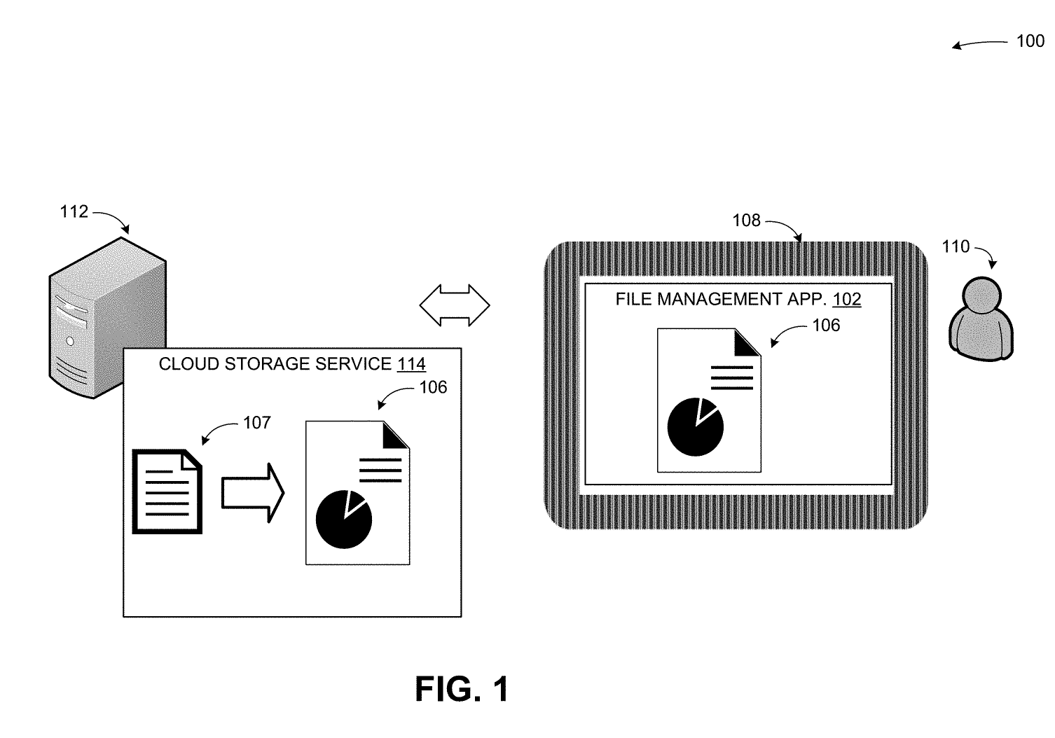

FIG. 1 is a conceptual diagram illustrating examples of providing an instant preview of a cloud based file, according to embodiments.

In a diagram 100, a computing device 108 may execute (or provide) a file management application 102. The computing device 108 may include a desktop device and/or a mobile device application(s) such as the file management application 102. The computing device 108 may interact with a server 112 that executes a cloud storage service 114. A service (such as the cloud storage service 114) may include an application performing operations in relation to a client application (such as the file management application 102) and/or a subscriber, among others. The server 112 may include and/or is part of a workstation, a data warehouse, a data center, and/or a cloud based distributed computing source, among others.

The computing device 108 may execute the file management application 102. The file management application 102 may detect an intent to preview a cloud based file 107. A cloud based file 107 may include a file hosted by the cloud storage service 114. For example, the cloud storage service 114 may partition the cloud based file 107 to multiple portions which may be distributed to a variety of storage components and/or storage providers. The file management application 102 may store a representation of the cloud based file 107. The representation may include a link and/or a portion of the cloud based file 107 (such as a beginning section of the cloud based file 107). Upon receiving an access request to the cloud based file 107, the cloud storage service 114 may retrieve and transmit the various partitions of the cloud based file 107 from the storage components and/or storage providers. The cloud storage service 114 may also optimize access to the cloud based file 107 based on resource availability and/or other criteria.

A client application (such as the file management application 102 or a file synchronization application) and/or a local operating system (executed by the computing device 108) may lack module(s) and/or feature(s) to render the cloud based file 107. The client application may consume extensive resources and/or may lack necessary resources to support module(s) and/or feature(s) to render a variety of file types stored by a vast resource such as the cloud storage service 114. As such, the client application, such as the file management application 102, may confirm an availability of a local previewer prior to an attempt to render the cloud based file 107.

Upon confirming a lack of a local previewer associated with the cloud based file 107, the file management application 102 may request a preview 106 from a cloud storage service 114 provided by the server 112. The cloud storage service 114 may host the cloud based file 107 and/or may have access to the cloud based file 107 provided by other cloud based storage service(s). The preview 106 may include a presentation of the cloud based file 107. The presentation may include image(s) of a content of the cloud based file 107. In another example scenario, the preview 106 may also duplicate interactive element(s) that may be located in the cloud based file 107 (such as a Tillable form). Upon receiving the preview 106 associated with the cloud based file 107 from the cloud storage service 114 provided by the server 112, the preview 106 may be rendered. The file management application 102 may render the preview 106. Alternatively, the file management application 102 may instruct the operating system (executed by the computing device 108) to have the preview 106 rendered by other application and/or module capable of rendering the preview 106.

The computing device 108 may communicate with the server 112, and/or other cloud based storage provider, through a network. The network may provide wired or wireless communications between network nodes such as the computing device 108, the server 112, and/or the cloud based storage provider, among others. Previous example(s) to provide an instant preview of the cloud based file 107 are not provided in a limiting sense. Alternatively, the file management application 102 may render the preview 106 as a desktop application, a workstation application, and/or a server application, among others.

A user 110 may interact with the file management application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 108, the file management application 102, embodiments are not limited to these components or system configurations and can be implemented with other system configuration employing fewer or additional components.

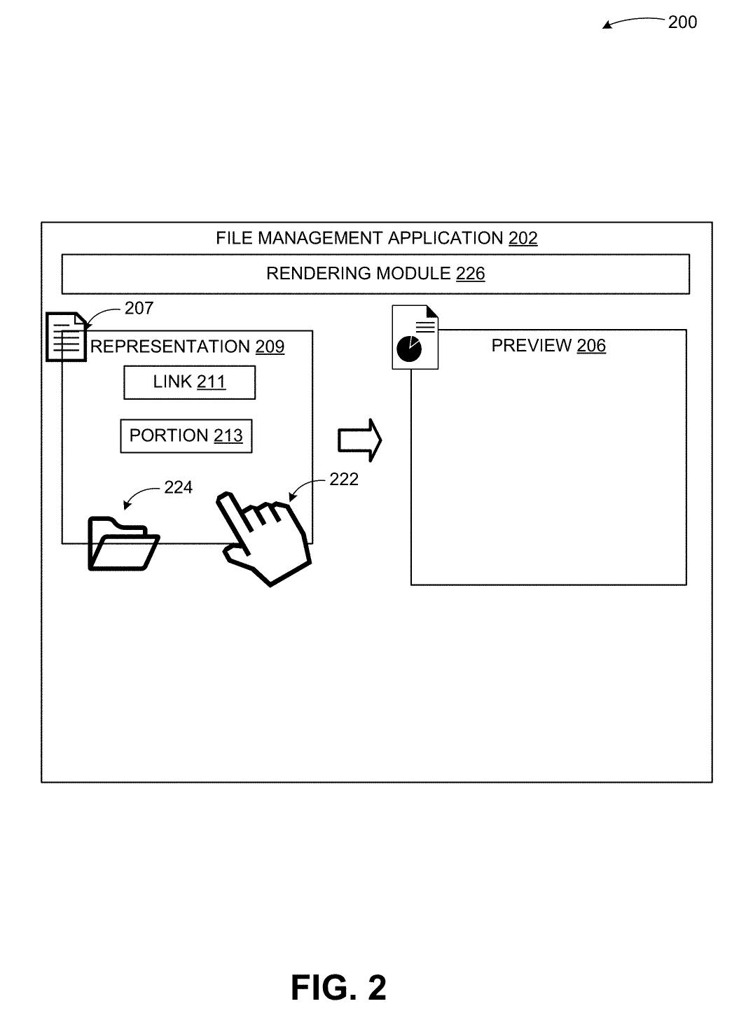

FIG. 2 is a display diagram illustrating example components of a file management application that provides an instant preview of a cloud based file, according to embodiments.

As illustrated in diagram 200, a rendering module 226 of a file management application 202 may detect an intent to access a cloud based file 207. A cloud based file 207 may include a file hosted by a cloud based storage provider. The representation 209 of the cloud based file 207 may be stored locally to allow an access to the cloud based file 207 that is hosted remotely (by a cloud based storage provider). The representation 209 may include a link 211 to the cloud based file 207. The link 211 may include an address to a location of the cloud based file 207. Furthermore, the representation 209 may include a portion 213 of a content of the cloud based file 207. The portion 213 may include a beginning section of the cloud based file 207. As such, when an access to the cloud based file 207 may be requested through an action on the representation 209, the portion 213 may be provided until a remaining portion of the cloud based file 207 is downloaded from the cloud based storage provider.

In an example scenario, an action may be detected on the representation 209 of the cloud based file 207 to access a content of the cloud based file 207. The action may be interpreted as an intent to preview the content of the cloud based file 207. The action may include a file open action 224, and/or a hover action 222, among others. The rendering module 226 may initially confirm that no local previewer exists for the cloud based file 207. The rendering module 226 may verify a type of the cloud based file 207 by determining a file extension associated with the representation 209. The rendering module 226 may query an operating system associated with the file management application 202 to confirm a lack of the local previewer.

Next, the rendering module 226 of the file management application 202 may intercept the file open action 224 executed on the representation 209 (of the cloud based file 207). The rendering module 226 may also detect default local operation(s) associated with the file open action 224. An example of a default local operation may include action(s) to open and render the cloud based file. Since, a local previewer does not exist for the cloud based file 207, the default local operation(s) may result in error(s) associated with an attempt to preview the cloud based file 207 (as a result of the file open action 224 applied on the representation 209). As such, the rendering module 226 may overwrite the default local operation(s) with operation(s) that include transmitting a request for the preview 206 associated with the cloud based file 207 and rendering the preview 206 upon receiving the preview 206 from the cloud based storage provider.

Alternatively, a hover action 222 over the representation 209 of the cloud based file 207 may be detected as an intent to preview the cloud based file 207. Upon confirming that no local previewer exists for the cloud based file 207, the preview 206 may be requested from the cloud based storage provider associated with the cloud based file 207. Upon receiving the preview 206 from the provider (such as a cloud storage service), the preview 206 may be rendered while the hover action 222 persists over the representation 209. For example, the preview 206 may be rendered during a time period when the hover action 222 is detected as over a thumbnail of the cloud based file 207 (as the representation 209).

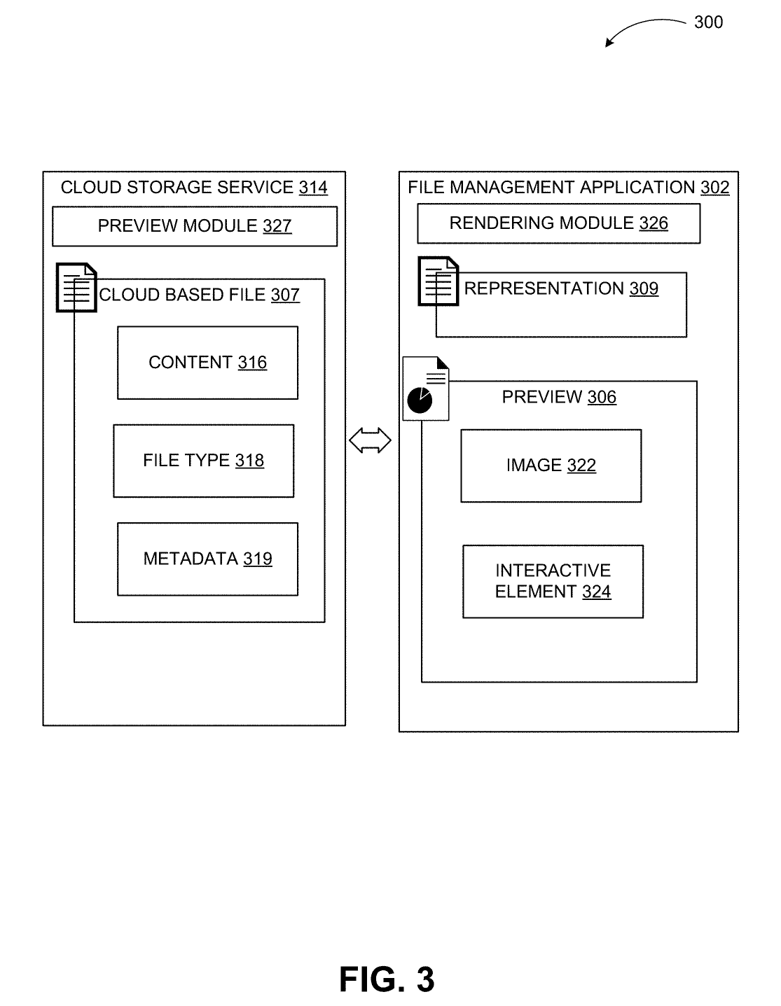

FIG. 3 is a display diagram illustrating components of a scheme to provide an instant preview of a cloud based file, according to embodiments.

As shown in a diagram 300, a rendering module 326 of file management application 302 may request a preview 306 of a cloud based file 307 upon detecting an intent to preview the cloud based file 307. The rendering module 326 may access a metadata 319 of the cloud based file 307 (by querying a cloud storage service 314) to determine a file type 318 of the cloud based file 307. The metadata 319 may list the file type 318 of the cloud based file 307. Alternatively, information located in the metadata 319 may be analyzed to determine the file type 318. For example, the information in the metadata 319 may describe pixel size of the cloud based file 307 from which the rendering module 326 may infer an image based file type as the file type 318 of the cloud based file 307. Furthermore, the metadata 319 may be accessed through a representation 309 of the cloud based file 307 that may be hosted locally to the file management application 302. The metadata may be detected as part of the representation 309 of the cloud based file 307. Upon confirming that no local previewer exists to render the cloud based file 307, the file management application 302 may request the preview 306.

The rendering module 326 of the file management application 302 may instruct a preview module 327 of the cloud storage service 314 to generate the preview 306 with an image 322 and/or other image(s) that illustrate a content 316 of the cloud based file 307. In another example scenario, the preview module 327 of the cloud storage service 314 may detect the cloud based file 307 as having an interactive element 324 such as a user interface element that allows a user to interact with the content 316 of the cloud based file 307. The preview module 327 may insert the interactive element 324 into the preview 306 to duplicate a functionality associated with the interactive element 324 in the cloud based file 307. Alternatively, the interactive element 324 may be reformatted and/or reconfigured for the preview 306 to reproduce a purpose/functionality served in the cloud based file 307. For example, a textbox that may be located in a cloud based file 307 may be reconfigured to include a text entry element within the preview 306.

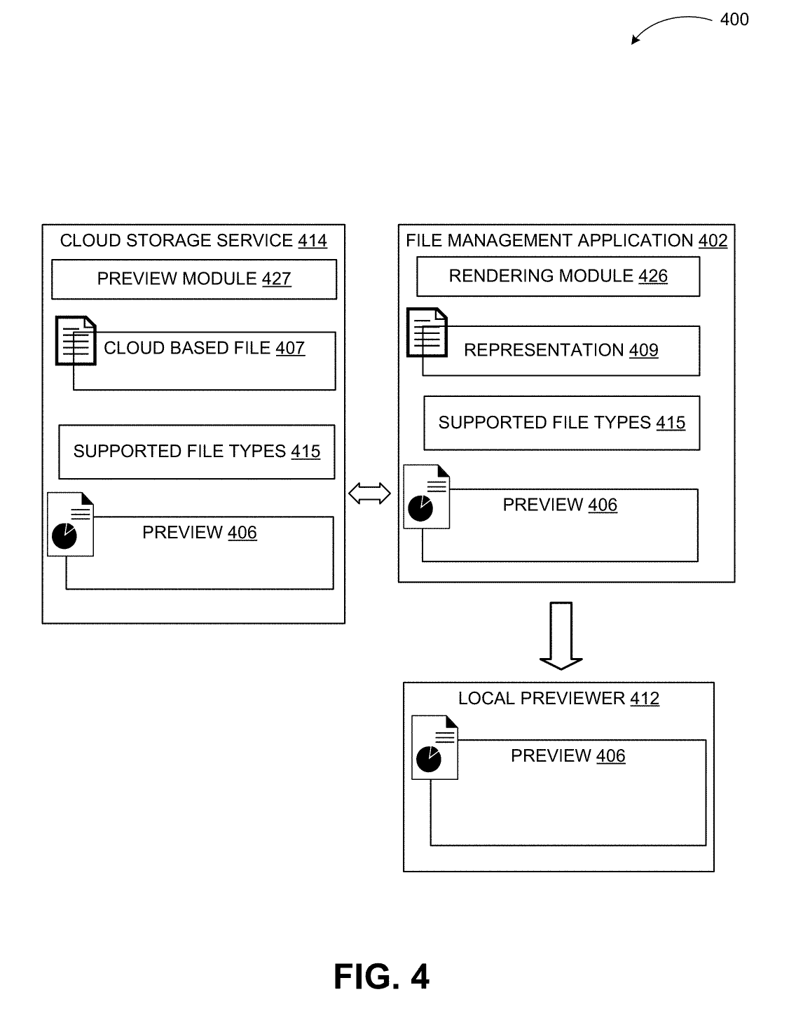

FIG. 4 is a display diagram illustrating another example of a scheme to provide an instant preview of a cloud based file, according to embodiments.

As shown in a diagram 400, a rendering module 426 of a file management application 402 may request a preview module 427 of a cloud storage service 414 to generate a preview 406 of a cloud based file 407 upon detecting a preview action on a representation 409 of the cloud based file 407 (that is hosted locally). The rendering module 426 may transmit a list of supported file types 415 to the preview module 427. The supported file types 415 may include a type of file which a local previewer 412 may be capable of rendering. For example, an operating system associated with the file management application 402 and/or the file management application 402 may have access to the local previewer 412 that is capable of rendering an image based file type. As such, the rendering module 426 may list the image based file type as one of the supported file types 415. The rendering module 426 may transmit the image based file type to the preview module 427 as one of the supported file types 415 to induce the cloud storage service 414 to generate the preview 406 based on the image based file type (as one of the supported file types 415).

The preview module 427 of the cloud storage service 414 may access the supported file types 415 (that is received from the file management application 402) to determine how to format the preview 406. The preview module 427 may generate the preview 406 by formatting the preview 406 based on the supported file types 415. If more than one supported file types 415 are listed, then the preview module 427 may format the preview 406 based one or more of the supported file types 415 that are also supported by the preview module 427. For example, the supported file types 415 may list an image based file type and an animation based file type, however, the preview module 427 may be capable of rendering only image based file type. As such, the preview module 427 may select the image based file type, generate, and format the preview 406 based on the image based file type.

The file management application 402 may render the preview 406 through a local previewer 412 (that displays the preview 406). Alternatively, the file management application 402 may instruct the operating system (associated with the file management application 402) to initiate the local previewer 412 to display the preview 406. The local previewer 412 may include a component of the file management application 402, a component of a local operating system, and/or a stand-alone application.

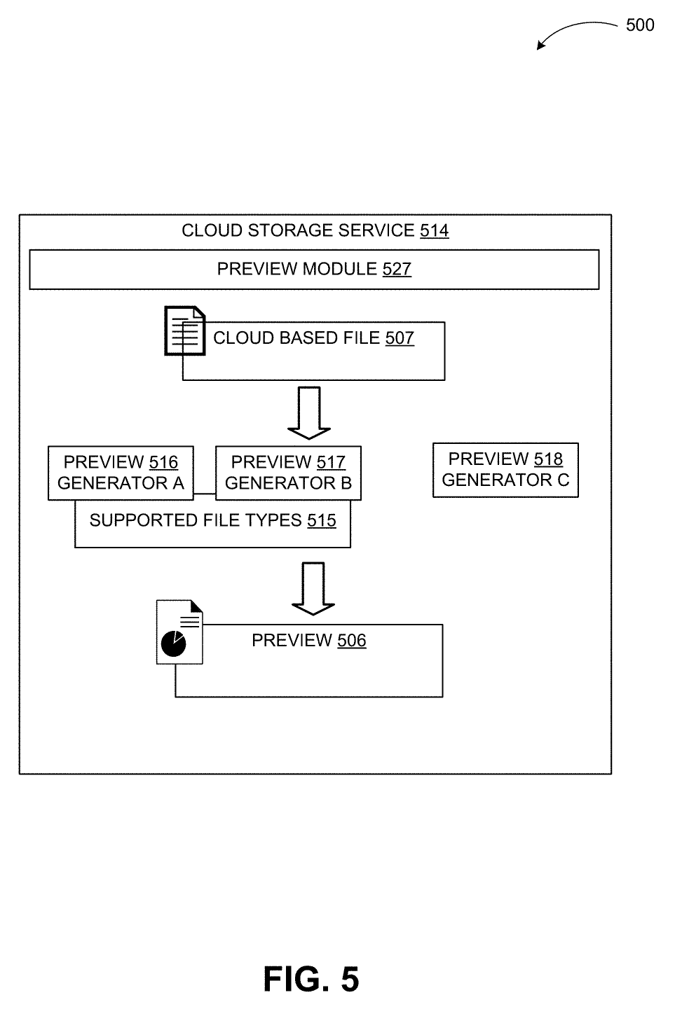

FIG. 5 is a display diagram illustrating an additional example of a scheme to provide an instant preview of a cloud based file, according to embodiments.

As shown in a diagram 500, a preview module 527 of a cloud storage service 514 may process a cloud based file 507 through one or more preview generators based on a file type associated with supported file types 515. A preview generator may include a module and/or a component of the cloud storage service 514 that may generate and format the preview 506 based on a specific file type. A client application such as a file management application may transmit a list of the supported file types 515 which the file management application may be capable of rendering.

The preview module 527 may analyze the supported file types 515 and select a preview generator A 516 and a preview generator B 517 to generate a preview 506 and other preview(s) that may be formatted based on file type(s) associated with the each of the preview generators. For example, the supported file types 515 may list support for an image based file type and an animation based file type. The preview module 527 may select the preview generator A 516 to generate the preview 506 that is formatted as an image based file type. The preview module 527 may select the preview generator B 517 to generate the preview 506 that is formatted as an animation based file type.

In another example scenario, the preview module 527 may select one of the preview generator A 516 and the preview generator B 517 to provide the client application (the file management application) with the preview 506. Alternatively, the preview module 527 may provide the file management application (the client application) with multiple copies of the preview 506 that are formatted based on the supported file types 515.

In an additional example scenario, the preview module 527 may receive other list of supported file types for formatting the cloud based file 507 (and/or other cloud based file) from the client application. The preview module 527 may determine that no preview generator(s) exist to format the cloud based file 507 based on the supported file types. In such a scenario, the preview module 527 may request a preview generator C 518 from a preview generator provider that is capable of formatting the cloud based file 507 based on the supported file types. Upon generating and formatting the preview 506 using the preview generator C 518, the preview module 527 may register and save the preview generator C 518 (for future use) as correlated with the supported file types provided by the client application.

As discussed above, the file management application may be employed to perform operations to provide an instant preview of a cloud based file. An increased performance and efficiency improvement with the file management application 102 and/or the cloud based storage service 114 may occur as a result of automatically generating a preview from a cloud based file and providing the preview through the file management application 102 by at least removing manual process(es) needed to locate a previewer and configuring the previewer to render an unsupported file such as the cloud based file. Additionally, confirming a lack of a local previewer, requesting the preview, generating the preview, and/or rendering the preview based operation(s) and process(es) executed by the file management application 102 and/or the cloud storage service 114, and may reduce processor load, increase processing speed, conserve memory, and reduce network bandwidth usage.

Embodiments, as described herein, address a need that arises from a lack of efficiency to provide an instant preview of a cloud based file. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Providing an instant preview of a cloud based file may be implemented in configurations employing fewer or additional components in applications and user interfaces. Furthermore, the example schema and components shown in FIG. 1 through 5 and their subcomponents may be implemented in a similar manner with other values using the principles described herein. Moreover, example systems and scenarios are described using the term “file management application” herein. A file management application may coordinate various aspects of data managements such as storage and also include synchronization (that is, synchronization of locally stored data with cloud stored data and vice versa).

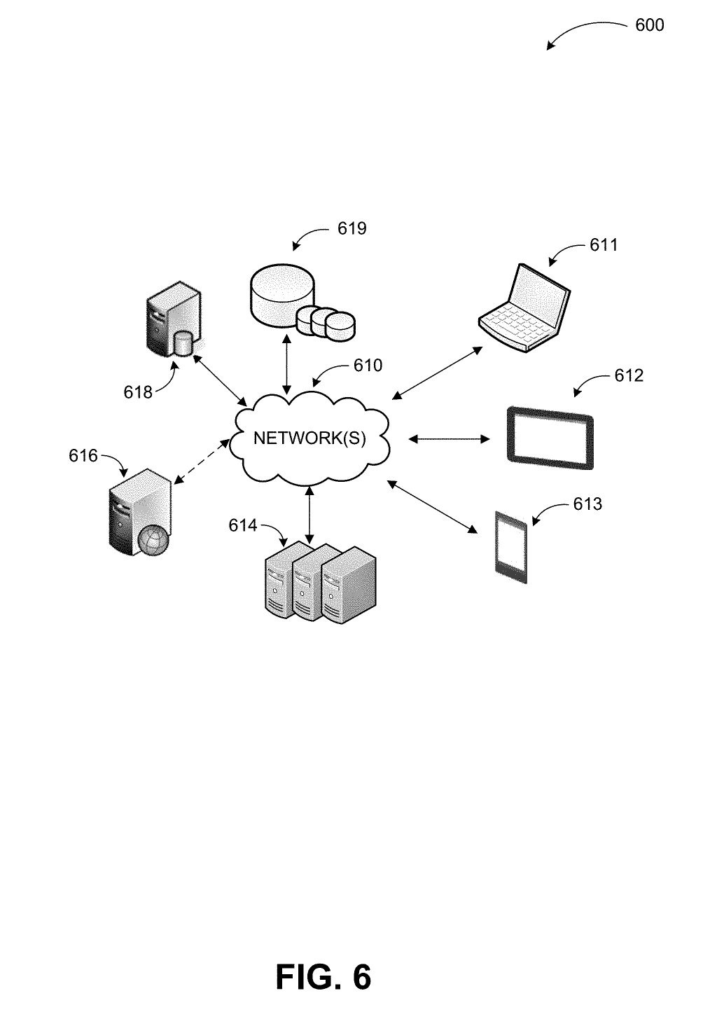

FIG. 6 is an example networked environment, where embodiments may be implemented. A file management application and/or a cloud storage service configured to provide an instant preview of a cloud based file may be implemented via software executed over one or more servers 614 such as a hosted service. The platform may communicate with client applications on individual computing devices such as a smart phone 613, a mobile computer 612, or desktop computer 611 (client devices') through network(s) 610.

Client applications executed on any of the client devices 611-613 may facilitate communications via application(s) executed by servers 614, or on individual server 616. A file management application may detect an intent to preview the cloud based file. Next, a lack of a local previewer associated with the cloud based file may be confirmed. A preview may be requested from a server associated with the cloud based file. The preview may include a presentation of the cloud based file. Upon receiving the preview associated with the cloud based file from the server, the preview may be rendered. The file management application and/or a cloud storage service may store data associated with the cloud based file in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide an instant preview of a cloud based file. Furthermore, the networked environments discussed in FIG. 6 are for illustration purposes only. Embodiments are not limited to the example applications, modules, or processes.

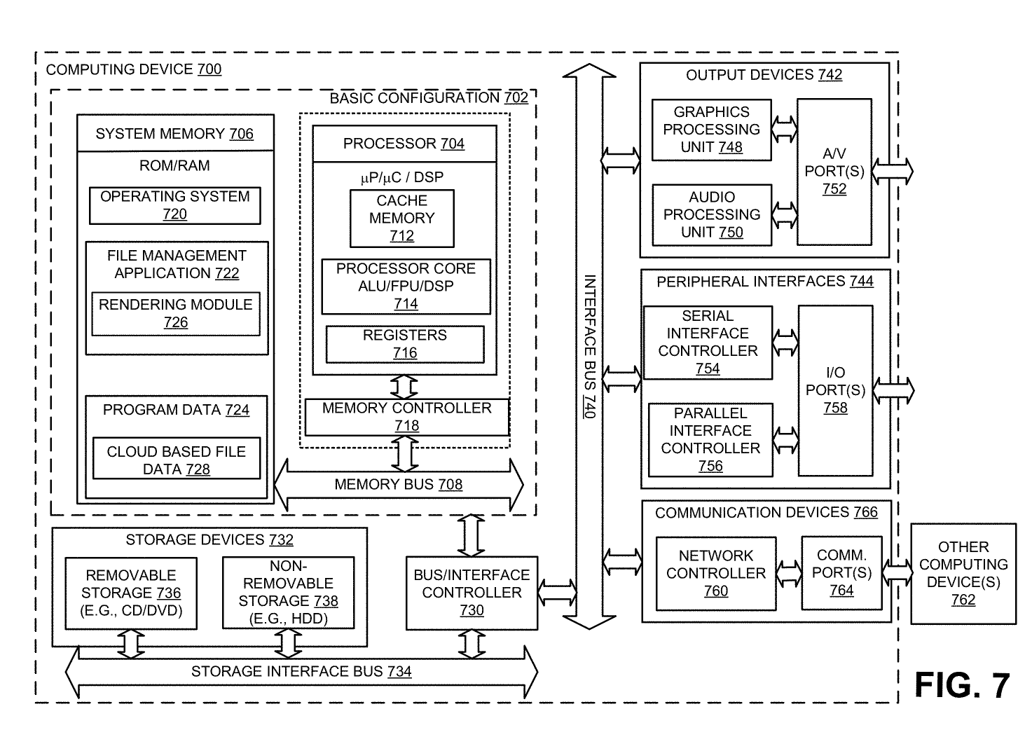

FIG. 7 is a block diagram of an example computing device, which may be used to provide an instant preview of a cloud based file, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), a graphics processing unit (GPU), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a file management application 722, and a program data 724. The file management application 722 may include components such as a rendering module 726. The rendering module 726 may execute the processes associated with the file management application 722. The rendering module 726 may detect an intent to preview the cloud based file. Next, a lack of a local previewer associated with the cloud based file may be confirmed. A preview may be requested from a server associated with the cloud based file. The preview may include a presentation of the cloud based file. Upon receiving the preview associated with the cloud based file from the server, the preview may be rendered.

Input to and output out of the file management application 722 may be transmitted through a communication device 766 that may be communicatively coupled to the computing device 700. The communication device 766 may provide wired and/or wireless communication. The program data 724 may also include, among other data, an cloud based file data 728, or the like, as described herein. The cloud based file data 728 may include a metadata, a link, and/or a portion associated with the cloud based file, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example of the communication device(s) 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a specialized server, mainframe, or similar computer, which includes any of the above functions. The computing device 700 may also be implemented as a personal computer including both laptop computer and non-laptop computer configurations. Additionally, the computing device 700 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide an instant preview of a cloud based file. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

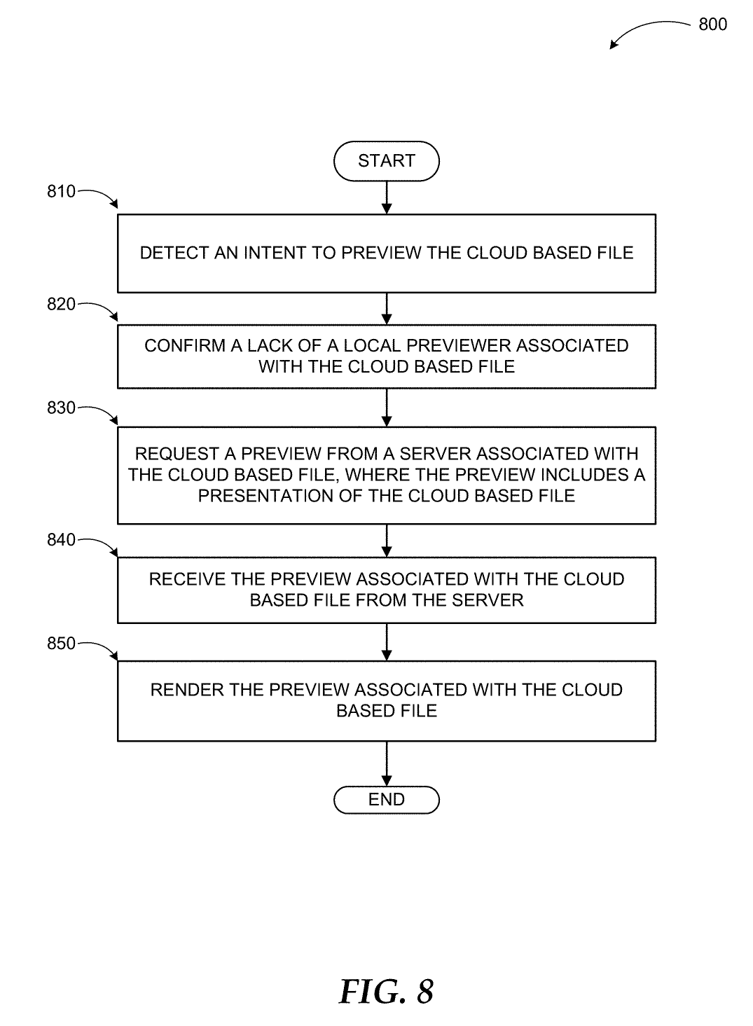

FIG. 8 is a logic flow diagram illustrating a process for providing an instant preview of a cloud based file. Process 800 may be implemented on a computing device, such as the computing device 700 or another system.

Process 800 begins with operation 810, where a file management application may detect an intent to preview a cloud based file. The intent may be detected as an action applied on a representation of the cloud based file. Next, at operation 820, a lack of a local previewer associated with the cloud based file may be confirmed. The local previewer may include a module, a component, and/or a stand-alone application associated with the file management application that is capable of displaying a content of the cloud based file.

At operation 830, a preview may be requested from a cloud storage service of a server associated with the cloud based file. The preview may include a presentation of the cloud based file. The presentation may include a content of the cloud based file that is formatted based on a file type that is supported by a local previewer that is available to the file management application for rendering the preview. At operation 840, the preview associated with the cloud based file may be received from the cloud storage service of the server. At operation 850, the preview may be rendered. The file management application may instantiate the local previewer (capable of rendering the preview) to render the preview. Alternatively, the file management application may instruct a local operating system (associated with the file management application) to initiate operation(s) to render the preview.

The operations included in process 800 is for illustration purposes. Providing an instant preview of a cloud based file may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to examples, a means for providing an instant preview of a cloud based file is described. The means may include a means for detecting an intent to preview the cloud based file; confirming a lack of a local previewer associated with the cloud based file; a means for requesting a preview from a server associated with the cloud based file, where the preview includes a presentation of the cloud based file using a previewer registered with the server; a means for receiving the preview associated with the cloud based file from the server; and a means for rendering the preview associated with the cloud based file.

According to some examples, a method to provide an instant preview of a cloud based file is described. The method may include detecting an intent to preview the cloud based file; confirming a lack of a local previewer associated with the cloud based file; requesting a preview from a server associated with the cloud based file, wherein the preview includes a presentation of the cloud based file using a previewer registered with the server; receiving the preview associated with the cloud based file from the server; and rendering the preview associated with the cloud based file.

According to other examples, the preview may include an interactive element associated with the cloud based file. The preview may enable limited editing functionality of a content of the cloud based file. The server may be identified as hosting the cloud based file. The method may further include detecting a hover action over a representation of the cloud based file as the intent to preview the cloud based file; and rendering the preview associated with the cloud based file during the hover action. The representation associated with the cloud based file may include one or more of a thumbnail, a shortcut, and a link associated with the cloud based file. The method may also include intercepting a file open action associated with the cloud based file; detecting one or more default local operations associated with the file open action; and overwriting the one or more default local operations with other operation that includes requesting the preview associated with the cloud based file to the server.

According to further examples, confirming the lack of the local previewer may include transmitting a request to a local operating system to render the cloud based file with the local previewer associated with the cloud based file; and receiving a notification from the local operating system that describes the lack of the local previewer associated with the cloud based file. Requesting the preview from the server associated with the cloud based file may include providing a list of supported file types to the server, where one or more local previewers exist for each of the supported file types; and transmitting an instruction to the server to format the preview associated with the cloud based file based on one of the supported file types. Requesting the preview from the server associated with the cloud based file may also include identifying supported file types that have one or more local previewers; determining a selection of the supported file types, where the cloud based file is associated with the selection of the supported file types; and transmitting an instruction to the server to format the preview associated with the cloud based file based on the selection of the supported file types.

According to other examples, a computing device configured to provide an instant preview of a cloud based file is described. The computing device may include a communication device configured to facilitate communication between a server and the computing device, where the computing device is configured to execute a file management application; a memory configured to store instructions; one or more processors coupled to the memory and the communication device, where the one or more processors, in conjunction with the instructions stored in the memory, execute a rendering module of the file management application. The rendering module may detect a preview action on a local representation of the cloud based file; confirm a lack of a local previewer associated with the cloud based file; request, through the communication device, a preview from the server associated with the cloud based file, where the preview includes a presentation of a content of the cloud based file using a previewer registered with the server; receive, through the communication device, the preview associated with the cloud based file from the server; and render the preview associated with the cloud based file.

According to some examples, the local representation of the cloud based file may include a link to the cloud based file and a portion of the content of the cloud based file. The rendering module may be further configured to request, through the communication device, a second preview associated with a second cloud based file from the server; and receive, through the communication device, a notification from the server, wherein the notification describes an inability to generate the second preview. The rendering module may be further configured to identify a second server associated with the second cloud based file; request, through the communication device, the second preview associated with the second cloud based file from the second server, receive, through the communication device, the second preview associated with the second cloud based file; and render the second preview associated with the second cloud based file. The rendering module may also be configured to display the notification that describes the inability to generate the second preview.

According to further examples, a server configured to provide an instant preview of a cloud based file is described. The server may include a communication device configured to facilitate communication between a client device and the server, where the server is configured to execute a cloud storage service; a memory configured to store instructions; one or more processors coupled to the memory and the communication device, where the one or more processors, in conjunction with the instructions stored in the memory, execute a preview module of the cloud storage service. The preview module may receive, through the communication device, a request for a preview associated with the cloud based file from the client device; generate the preview based on the cloud based file, where the preview includes a presentation of a content of the cloud based file generated through a preview generator registered with the server; and transmit, through the communication device, the preview associated with the cloud based file to the client device.

According to other examples, the preview module may be further configured to identify the preview generator associated with the cloud based file from a list of preview generators registered with the server. The preview module may also be configured to upon a failure to identify the preview generator associated with the cloud based file, query, through the communication device, an external source for the preview generator associated with the cloud based file; receive, through the communication device, the preview generator associated with the cloud based file from the external source; and process the cloud based file with the preview generator to create the preview. The preview module may be further configured to register the preview generator as associated with the cloud based file at the server. The external source may include one or more of other cloud storage server, a preview generator provider, and a file rendering provider.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide an instant preview of a cloud based file, the method comprising:
detecting an intent to preview the cloud based file;
confirming a lack of a local previewer associated with the cloud based file;
requesting a preview from a server associated with the cloud based file, wherein the preview includes a presentation of the cloud based file using a previewer registered with the server;
receiving the preview associated with the cloud based file from the server; and
rendering the preview associated with the cloud based file.

2. The method of claim 1, wherein the preview includes an interactive element associated with the cloud based file.

3. The method of claim 1, wherein the preview enables limited editing functionality of a content of the cloud based file.

4. The method of claim 1, wherein the server is identified as hosting the cloud based file.

5. The method of claim 1, further comprising:
detecting a hover action over a representation of the cloud based file as the intent to preview the cloud based file; and
rendering the preview associated with the cloud based file during the hover action.

6. The method of claim 5, wherein the representation associated with the cloud based file includes one or more of a thumbnail, a shortcut, and a link associated with the cloud based file.

7. The method of claim 1, further comprising:
intercepting a file open action associated with the cloud based file;
detecting one or more default local operations associated with the file open action; and
overwriting the one or more default local operations with other operation that includes requesting the preview associated with the cloud based file to the server.

8. The method of claim 1, wherein confirming the lack of the local previewer comprises:
transmitting a request to a local operating system to render the cloud based file with the local previewer associated with the cloud based file; and
receiving a notification from the local operating system that describes the lack of the local previewer associated with the cloud based file.

9. The method of claim 1, wherein requesting the preview from the server associated with the cloud based file comprises:
providing a list of supported file types to the server, wherein one or more local previewers exist for each of the supported file types; and
transmitting an instruction to the server to format the preview associated with the cloud based file based on one of the supported file types.

10. The method of claim 1, wherein requesting the preview from the server associated with the cloud based file comprises:
identifying supported file types that have one or more local previewers;
determining a selection of the supported file types, wherein the cloud based file is associated with the selection of the supported file types; and
transmitting an instruction to the server to format the preview associated with the cloud based file based on the selection of the supported file types.

11. A computing device configured to provide an instant preview of a cloud based file, the computing device comprising:
a communication device configured to facilitate communication between a server and the computing device, wherein the computing device is configured to execute a file management application;
a memory configured to store instructions;
one or more processors coupled to the memory and the communication device, wherein the one or more processors, in conjunction with the instructions stored in the memory, execute a rendering module of the file management application, the rendering module configured to:
detect a preview action on a local representation of the cloud based file;
confirm a lack of a local previewer associated with the cloud based file;
request, through the communication device, a preview from the server associated with the cloud based file, wherein the preview includes a presentation of a content of the cloud based file using a previewer registered with the server;
receive, through the communication device, the preview associated with the cloud based file from the server; and
render the preview associated with the cloud based file.

12. The computing device of claim 11, wherein the local representation of the cloud based file includes a link to the cloud based file and a portion of the content of the cloud based file.

13. The computing device of claim 11, wherein the rendering module is further configured to:
request, through the communication device, a second preview associated with a second cloud based file from the server; and
receive, through the communication device, a notification from the server, wherein the notification describes an inability to generate the second preview.

14. The computing device of claim 13, wherein the rendering module is further configured to:
identify a second server associated with the second cloud based file;
request, through the communication device, the second preview associated with the second cloud based file from the second server;
receive, through the communication device, the second preview associated with the second cloud based file; and
render the second preview associated with the second cloud based file.

15. The computing device of claim 13, wherein the rendering module is further configured to:
display the notification that describes the inability to generate the second preview.

16. A server configured to provide an instant preview of a cloud based file, the server comprising:
a communication device configured to facilitate communication between a client device and the server, wherein the server is configured to execute a cloud storage service;
a memory configured to store instructions;
one or more processors coupled to the memory and the communication device, wherein the one or more processors, in conjunction with the instructions stored in the memory, execute a preview module of the cloud storage service, the preview module configured to:
receive, through the communication device, a request for a preview associated with the cloud based file from the client device;
generate the preview based on the cloud based file, wherein the preview includes a presentation of a content of the cloud based file generated through a preview generator registered with the server; and
transmit, through the communication device, the preview associated with the cloud based file to the client device.

17. The server of claim 16, wherein the preview module is further configured to:
identify the preview generator associated with the cloud based file from a list of preview generators registered with the server.

18. The server of claim 16, wherein the preview module is further configured to:
upon a failure to identify the preview generator associated with the cloud based file,
query, through the communication device, an external source for the preview generator associated with the cloud based file;
receive, through the communication device, the preview generator associated with the cloud based file from the external source; and
process the cloud based file with the preview generator to create the preview.

19. The server of claim 18, wherein the preview module is further configured to:
register the preview generator as associated with the cloud based file at the server.

20. The server of claim 18, wherein the external source includes one or more of other cloud storage server, a preview generator provider, and a file rendering provider.
